(19) United States
(12) Patent Application Publication
(10) Pub. No.: US 2019/0005688 A1
(43) Pub. Date: Jan. 3, 2019

(54) DYNAMIC BADGE GENERATION AND APPLICATION PRESENTATION

(71) Applicant: Microsoft Technology Licensing, LLC, Redmond, WA (US)

(72) Inventors: Daniel Perez Alvarez, Seattle, WA (US); Jesse Martin, Bellevue, WA (US)

(21) Appl. No.: 15/637,020

(22) Filed: Jun. 29, 2017

(51) Int. Cl. G06T 11/20; G06Q 50/00; G06F 3/0481

(52) U.S. Cl. CPC G06T 11/203; G06F 3/04817; G06Q 50/01

(57) ABSTRACT

Non-limiting examples of the present disclosure relate to processing operations for dynamic badge generation and presentation, for example, within a user interface of an exemplary application/service. Data associated with a user account of an application may be accessed. As an example, the application may be a social networking application configured for team collaboration. A status of the user account is detected that relates to satisfaction of a badge count threshold for display of a specific badge within the application. In response to the detected status, a badge icon for the specific badge is dynamically generated. As an example, the application may be configured to call a process for execution of rendering operations that dynamically generates the exemplary badge icon. The badge icon may comprise image content that is rendered in real-time for the detected status. The badge icon may be presented through the user interface of the application.

### BACKGROUND

Badges are image objects, provided through a user interface of an application/service, on behalf of users to identify notifications, achievements, etc. for the user. In one instance, badges may be automatically earned from user interaction with the application/service (e.g. gamification) or an accounting of user activity. It is difficult to set badge counts for applications without using a hard-coded image for each count when the applications are running on certain operating systems. For instance, an application may require a developer to configure a specific badge count and hard-code fixed image content to display when that badge count is satisfied. This is inefficient from a processing standpoint as well as tedious for developers where a large number of badge counts and fixed images have to be hard-coded. Additionally, this limits user interaction with an application as the image content provided for badges is preset and may not be tailored for the user.

### SUMMARY

As such, non-limiting examples of the present disclosure relate to processing operations for dynamic badge generation and presentation, for example, within a user interface of an exemplary application/service. As an example, the application may be a social networking application that is configured for team collaboration. However, examples described herein are not so limited and may extend to any type of application/service that incorporates badge indications. Exemplary badge icons may be dynamically generated and present through a user interface of an application/service, for example, to provide customized notifications to a user in real-time.

Data associated with a user account of an application may be accessed. As an example, the application may be a social networking application configured for team collaboration. A status of the user account is detected that relates to satisfaction of a badge count threshold for display of a specific badge within the application. In response to the detected status, a badge icon for the specific badge is dynamically generated. As an example, the application may be configured to call a process for execution of rendering operations that dynamically generates the exemplary badge icon. The badge icon may comprise image content that is rendered in real-time for the detected status. The badge icon may be presented through the user interface of the application.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Non-limiting and non-exhaustive examples are described with reference to the following figures.

FIG. 1 illustrates an exemplary method related to dynamic generation and presentation of exemplary badges with which aspects of the present disclosure may be practiced.

FIG. 2 illustrates an example of a process flow for dynamic generation and presentation of exemplary badges with which aspects of the present disclosure may be practiced.

FIG. 3 is a block diagram illustrating an example of a computing device with which aspects of the present disclosure may be practiced.

FIGS. 4A and 4B are simplified block diagrams of a mobile computing device with which aspects of the present disclosure may be practiced.

FIG. 5 is a simplified block diagram of a distributed computing system in which aspects of the present disclosure may be practiced.

### DETAILED DESCRIPTION

Non-limiting examples of the present disclosure relate to processing operations for dynamic badge generation and presentation, for example, within a user interface of an exemplary application/service. Data associated with a user account of an application may be accessed. A status of the user account is detected, where the status relates to satisfaction of a badge count threshold for display of a specific badge within a user interface of an application. In response to the detected status, a badge icon for the specific badge is dynamically generated.

In one example, an application may interface with one or more other applications/services to achieve dynamic rendering of an exemplary badge icon. For instance, an exemplary application/service executes processing operations to call a framework for application generation (e.g. application programming interface (API)), for example, to handle real-time rendering of an exemplary badge icon. An exemplary framework for application generation may be utilized to present a user interface for an application/service. In such an instance, a rendering process is executed by a framework for application generation that is separate from a main process of the framework for application generation. The rendering process may dynamically render content for an exemplary badge icon and utilize a document object model (DOM) to configure the content for display within the application. Data for the badge icon may be transmitted back to the main process of the framework for application generation and configured for presentation within a user interface of an exemplary application/service (e.g. social networking application). In any example, a dynamically generated badge icon may be presented through the user interface of the application/service.

Examples of the present disclosure may be configured to work with any API that has access to a browser engine. For instance, an API that has access to a browser engine can be configured to utilize an exemplary document object model to create a markup language image from a scalable vector graphic, render the graphic as a markup language element, encode the data inside a markup language canvas as a link and utilize that link to turn that image into a badge icon in a user interface of an exemplary application/service. An exemplary API may be configured with an architecture that distributes processes separately. For example, an exemplary API architecture may separate a main processing (one that has access to operating system methods) from that of a rendering process (one that has access to a browser's document object model). In such an instance, the separate processes of the API architecture may be configured to communicate/interface through inter-process communication (IPC). While there are benefits to separation of a main process from rendering process, as described herein, exemplary processing operations may also be configured to work with API architectures that do not separate a main process from a rendering process.

Accordingly, the present disclosure provides a plurality of technical advantages including but not limited to: more efficient code that does not require additional lines of code nor hard-coded image content to be hard-coded, better management of resource/processing efficiency for applications and computing devices running applications, e.g. less data/storage needed for application/service (as additional code and pre-stored image content does not need to be stored), ability to customize/personalize badge content, ability to manipulate form of image content for exemplary badge creation, adaption of existing frameworks for native application building to enable dynamic creation of exemplary badge icons, extensibility to share dynamically generated badge icons with other applications/services including a suite of applications provided by a platform through a distributed networking service and improved user interaction with application/services in which exemplary badge icons are dynamically generated on behalf of a user, among other examples.

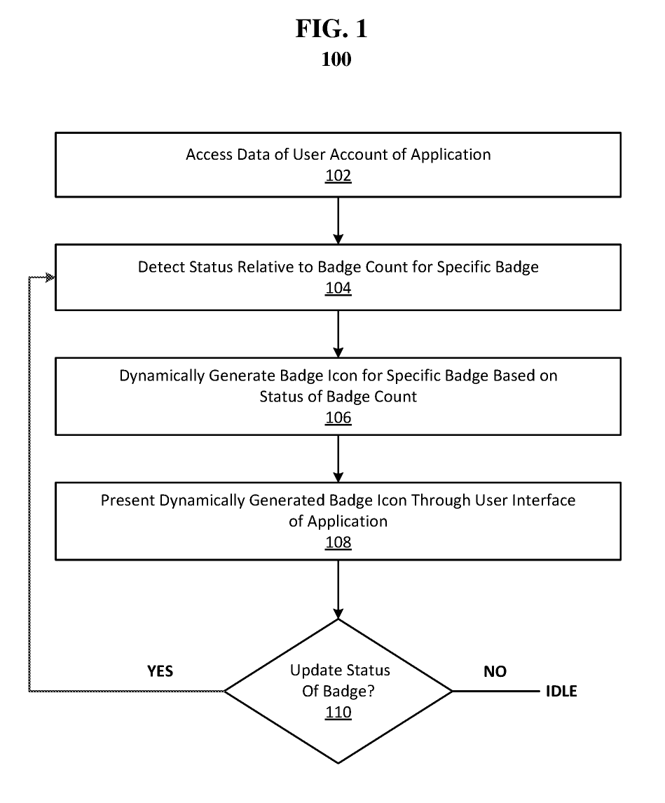

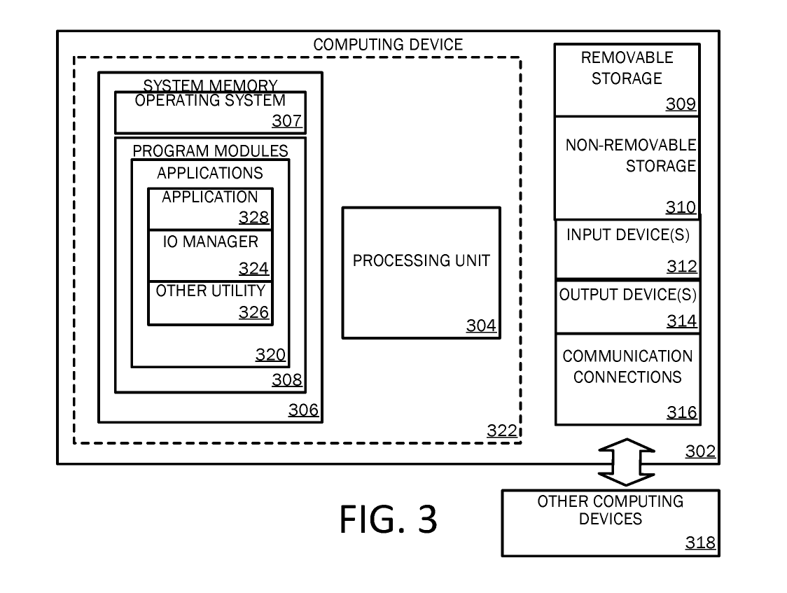

FIG. 1 illustrates an exemplary method 100 related to dynamic generation and presentation of exemplary badges with which aspects of the present disclosure may be practiced. As an example, method 100 may be executed by an exemplary processing device and/or system such as those shown in FIGS. 3-5. In examples, method 100 may execute on a device comprising at least one processor configured to store and execute operations, programs or instructions. Operations performed in method 100 may correspond to operations executed by a system and/or service that execute computer programs, application programming interfaces (APIs), neural networks or machine-learning processing, among other examples. As an example, processing operations executed in method 100 may be performed by one or more hardware components. In another example, processing operations executed in method 100 may be performed by one or more software components. In some examples, processing operations described in method 100 may be executed by one or more applications/services associated with a web service that has access to a plurality of application/services, devices, knowledge resources, etc. Processing operations described in method 100 may be implemented by one or more components connected over a distributed network.

Method 100 begins at processing operation 102, where data associated with a user account of an exemplary application may be accessed. As an example, an application may be a social networking application that is configured for team collaboration. However, examples described herein are not so limited and may extend to any type of application/service that incorporates badge notification processing. An example of an exemplary social networking application is Yammer® providing a social networking service that is used for private communications within specific organizations such as companies. In one example, an exemplary application/service is configured to access (processing operation 102) data associated with a user account when a user logs into the application/service. In another example, an application/service is configured to access (processing operation 102) data associated with a user account in real-time, for example, when a user is logged into the application/service. In yet another example where a user is already logged into the application/service, data associated with a user account may be accessed (processing operation 102) periodically (e.g. at predetermined intervals) as set by developers. In any example, user account data may be accessed (processing operation 102) for reasons including evaluation of badge counts that indicate a status of a user account with respect to earning specific badges.

Flow of method 100 may proceed to processing operation 104, where a status of the user account is detected relating to satisfaction of a badge count threshold for display of a specific badge within a user interface of an application. Badges are image objects, provided through a user interface of an application/service, on behalf of users to identify notifications, achievements, etc. for the user. In one instance, badges may be automatically earned from user interaction with the application/service (e.g. gamification) or an accounting of user activity. For example, a user account may be part of a project group within an organization, where a badge may be achieved through a social networking application/service for completion of a project milestone, sharing communications with other team members, recognition awards. In such an instance, a user account of an exemplary social networking application may be configured to earn badges that recognize achievements/awards for work as an employee within the company. However, in alternative examples, an exemplary application/service is also configured to provide badges for specific in-application notifications including but not limited to: message statuses (e.g. read/unread message content), push notifications and updates to user account data including team/groups within an organization, among other examples. In one example, an exemplary badge icon is a user interface element that is placed atop or near a context that conveys information about the context. For instance, a badge icon may be rendered to indicate a number of unread messages in an electronic mailbox of an exemplary application/service. The present disclosure is particularly useful for generation and rendering of exemplary badge icons on specific operating systems (e.g. Windows®) where underlying operating system APIs are not configured for dynamic presentation and generation of exemplary badge icons.

A status associated with a badge count threshold is a real-time indication of a state of the user account with respect to satisfying a badge count to achieve a specific badge. For instance, an exemplary status (e.g. badge status or badge count status) may indicate that a. specific badge is earned, unearned, how far away a user is from earning the specific badge, specific content associated with a badge icon (e.g. number of messages, number of unread messages, user specific data) etc. Specific badges and badge counts for specific badges may vary where developers can set specific badges and specific badge counts. In such a way, an exemplary application/service is configured to enhance a user experience, for example, by providing real-time updates as to a status of a badge that may include data that is useful to the user for continued interaction with the application/service. An exemplary status may be detected through a main process of an application/service.

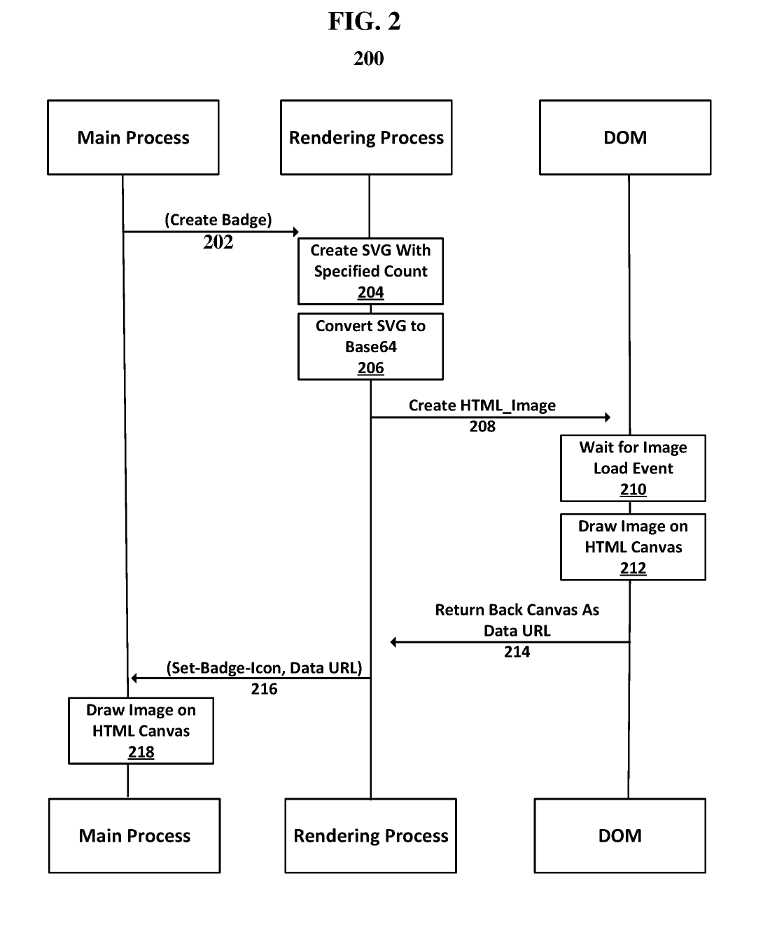

In response to the detected status, a badge icon for the specific badge is dynamically generated (processing operation 106). An exemplary badge icon is user interface features that is presented through a user interface of an exemplary application/service to indicate a status relative to a specific badge. In examples, the badge icon may be dynamically generated to reflect a detected status relative to a badge count. Dynamic generation (processing operation 106) comprises dynamic rendering of an exemplary badge icon, where content of a badge icon is configured for presentation within an exemplary application/service. Further, non-limiting examples of processing related to dynamic rendering of an exemplary badge icon is provided in the description of process flow 200 (FIG. 2).

Some operating systems do not expose an application icon badge count application programming interface (API). In web pages, calling native graphical user interface (GUI) related APIs is not allowed because managing native GUI resources in web pages is very dangerous and it is easy to leak resources. If a developer wants to perform GUI operations in a web page, the developer may need to make sure the rendering process of the web page communicates with the main process to request that the main process perform those operations. As such, an API may be utilized to enable communication between the main process and rendering processes.

Examples of the present disclosure may be configured to work with any API that has access to a browser engine. For instance, an API that has access to a browser engine can be configured to utilize an exemplary document object model to create a markup language image from a scalable vector graphic, render the graphic as a markup language element, encode the data inside a markup language canvas as a link and utilize that link to turn that image into a badge icon in a user interface of an exemplary application/service. An exemplary API may be configured with an architecture that distributes processes separately. For example, an exemplary API architecture may separate a main processing (one that has access to operating system methods) from that of a rendering process (one that has access to a browser's document object model). In such an instance, the separate processes of the API architecture may be configured to communicate/interface through inter-process communication (IPC). While there are benefits to separation of a main process from rendering process, as described herein, exemplary processing operations may also be configured to work with API architectures that do not separate a main process from a rendering process.

In one example, an exemplary application/service executes processing operations to call a framework for application generation, for example, to handle real-time rendering of an exemplary badge icon. An exemplary framework for application generation may be an application programming interface (API) that interfaces with an exemplary application/service that presents a user interface. In many examples, an exemplary application/service and/or framework for application generation are web-based where interfacing may occur over a network connection. However, examples described herein are not so limited.

A rendering process that is executed by a framework for application generation may be separate from a main process of the framework for application generation. The rendering process may dynamically render content for an exemplary badge icon and utilize a document object model (DOM) to configure the content for display within the application. In some instances, a framework for application generation that is being utilized does not have a DOM that is specifically tailored for purposes. However, many such applications are configured to run rendering processes that do have DOM access. Thus, examples described herein may comprise utilizing specific commands/functions to tailor a framework for application generation to work with an exemplary application/service. Data for the badge icon may be transmitted back to the main process of the framework for application generation and configured for presentation within a user interface of an exemplary application/service (e.g. social networking application).

Dynamically generating (processing operation 106) of the badge icon further comprises: rendering content (e.g. image content) in a markup language format (e.g. HTML, XML, etc.), generating a link to the rendered content and providing the link for presentation of the content as the badge icon. Consider an example where content being rendered for the badge icon is image content. In that example, rendering of the content may further comprise: creating a scalable vector graphic for the image content, converting the scalable vector graphic to binary data, generating a markup language tag for the image content based on the binary data, drawing the image content to a markup language canvas based on the markup language tag and generating the link based on a result of drawing the image content to the markup language canvas.

In any rendering example, content for an exemplary badge icon may be dynamically compiled where dynamic rendering includes dynamic content retrieval and selection of specific content to include in the badge icon. As an example, an exemplary badge icon may comprise content that is rendered in real-time for the detected status. Content that is included in the exemplary badge icon may comprise but is not limited to: image content, audio content, video content, text content, telemetric data, links, and contextual suggestions for users, among other examples. Content, that may be included within an exemplary badge icon, may be retrieved from any of a variety of data sources including but not limited to: content from the application, user-specific content that is retrieved from user accounts associated with the application, telemetric analysis of application data, content that is retrieved from other distributed applications/services including a suite of productivity applications associated with a user account, web search services, knowledge repositories of a platform (e.g. Microsoft®, Google®, etc.) that are connected with an exemplary application/service as well as image composition tools, among other examples.

In one instance, rendering, for dynamic generation of a badge icon, further comprises analyzing user specific user signal data collected from the application/service and selecting the image content for the badge icon based on an analysis of the specific user signal data. User signal data may comprise signal data collected from usage related to the user account and/or other user accounts of the application/service. User specific signal data is useful to help customize/personalize content presented in a badge icon on behalf of the user. In further examples, usage data from the application/service may be collected and analyzed to generate telemetric data. In this way, user-specific metrics, correspondence metrics with specific users as well as team-wide or organization-wide metrics can be generated and provided for the user, for example, within an exemplary badge icon or in association with an exemplary badge icon.

Once an exemplary badge icon is dynamically generated (processing operation 106), flow of method 100 may proceed to processing operation 108, where the dynamically generated badge icon is presented through the user interface of an exemplary application/service. In examples, a user interface of an exemplary application/service is updated, where a badge icon is presented (processing operation 108) to overlay an existing application icon (e.g. user interface feature). For instance, a social networking application/service may be configured to present (processing operation 108) icons for badges including unearned badges where an icon (e.g. unearned badge icon) may be updated with the dynamically generated badge icon once the badge is earned. In other instances, real-time updates to statuses for specific badges may be provided through the user interface, for example, how far away a user is from earning a badge, identification of badges that have not yet been reviewed/selected, etc.). In alternative examples, badge icons are generated for other types of notifications within an exemplary application/service including message notifications, user notifications, content updates, etc. A main process of an exemplary framework for application generation may be utilized to set the badge icon in a user interface of the application/service.

As identified above, some example of exemplar badge icons may comprise personalized content for the user where a badge icon for a specific badge presented to one user may be different from a badge icon for the same badge that is presented to another user. In other examples, telemetric data from application analysis may be included within an exemplary badge icon. In an alternative example, the user interface of an exemplary application/service is configured to update display based on a selection of an exemplary badge icon or other input such as rolling over the badge icon, where telemetric data, contextual suggestions or other content may be presented in association with a dynamically generated badge icon. That is, dynamic generation of a badge icon may comprise generating multiple layers of content that may increase user interaction and user satisfaction with an exemplary application/service during presentation (processing operation 108).

In examples where an API such as a framework for application generation is used for generation of a badge icon, data for the badge icon (created through rendering processing) may be transmitted back to the main process of the framework for application generation. In such an instance, the main process of the framework for application generation may execute operations to configure the content for presentation with an exemplary application/service. In one example, the main process of the framework for application generation may draw image content on an HTML canvas, for example, to present (processing operation 108) an exemplary badge icon in a web-based service for a social networking application.

Flow of method 100 may proceed to decision operation 110, where it is determined whether there is an update to a status of a specific badge. An exemplary application/service is configured to continuously re-check a badge count for specific badges. For example, a badge icon may be presented indicating that a specific badge is almost earned by the user account where the user takes subsequent action to earn the specific badge. In such an example, a badge icon may be dynamically re-generated and updated in real time. In examples where no update is to occur to a status of a specific badge, flow of method 100 branches NO and processing remains idle until subsequent update is to occur. In examples where an update is to occur to a status of a specific badge, flow of method 100 branches YES and processing returns back to processing operation 104, where a status of a user account is re-detected relative to a badge count for a specific badge.

FIG. 2 illustrates an example of a process flow 200 for dynamic generation and presentation of exemplary badges with which aspects of the present disclosure may be practiced. For example, process flow 200 illustrates an interaction between a main process for an exemplary framework for application generation (e.g. API), a rendering process of the framework for application and a document object model (DOM) that is accessed, which the rendering process may utilize to configure content for presentation within a user interface of an exemplary application/service. Examples described in process flow 200 may describe content as image content. However, as described in the foregoing, other types of content can be utilized for creation of a badge icon without departing from the spirit of the present disclosure.

As an example, process flow 200 may be executed by an exemplary processing device and/or system such as those shown in FIGS. 3-5. In examples, process flow 200 may execute on a device comprising at least one processor configured to store and execute operations, programs or instructions. Operations performed in process flow 200 may correspond to operations executed by a system and/or service that execute computer programs, application programming interfaces (APIs), neural networks or machine-learning processing, among other examples. As an example, processing operations executed in process flow 200 may be performed by one or more hardware components. In another example, processing operations executed in process flow 200 may be performed by one or more software components. In some examples, processing operations described in process flow 200 may be executed by one or more applications/services associated with a web service that has access to a plurality of application/services, devices, knowledge resources, etc. Processing operations described in process flow 200 may be implemented by one or more components connected over a distributed network.

Process flow 200 begins at processing operation 202, where processing for creation of an exemplary badge icon is initiated by a main process of an application/service. As identified in the foregoing, some operating systems do not expose an application icon badge count application programming interface (API). For example, Windows® operating system offers the ability to set an overlay icon atop an existing application icon within a user interface (UI) of an application/service. Processing operations for setting an exemplary badge icon over an existing UI icon are initiated from a main process of an application/service such as a framework for application generation. In examples, a main process of an application may send one or more commands to a rendering process (that is separate from the main process of the application) to initiate creation of an exemplary badge icon. Creating an exemplary badge icon (e.g. image content) with a DOM is much easier than trying to create an image outside of it, so the rendering processing may be configured to work with a DOM for creation of an exemplary badge icon. However, in alternative examples, rendering of an exemplary badge icon may not require the use of a DOM. As an example, a non-limiting example of a command that is transmitted in processing operation 202 may be similar to “create-badge-image′, 127” where 127 being the badge count to display in the image content.

Flow of process flow 200 may proceed to processing operation 204, where a scalable vector graphic (SVG) is created for a specific badge/badge count. As described in the foregoing (e.g. method 100 of FIG. 1), content can be dynamically retrieved and selected for inclusion within an exemplary badge icon. An SVG of content (singular or aggregated) may be created in processing operation 204. In some instances, an exemplary framework for application generation may only accept specific formats (e.g. JPEG or PNG) of content (e.g. image content), so the SVG may be converted to a different format.

At processing operation 206, a format of the content is converted from SVG to binary data (e.g. Base64). For instance, to convert (processing operation 206) the SVG into a PNG image, an HTML Image tag may be used. It may not be possible to save an SVG as a file blob and create a URL for display within a web page because that would dirty a markup language canvas. In such an instance, the content would be served from a file://URL, which canvas considers foreign. Dirty canvases are typically unable to be exported as image data. To account for this, the SVG may be converted to a binary format (e.g. Base64) using a Binary-to-ASCII Format (BTOA), for example, with a prefix of “data: image/svg+xml;base64” as a non-limiting example.

After the SVG is in Base64 format, the image content can be used to create (processing operation 208) a markup language format of the image content. For example, process flow may proceed to processing operation 208, where an HTML image is created for the rendered content. Examples for creating an HTML image from rendered content are known to one skilled in the art. The HTML image is then loaded (processing operation 210) into the DOM for further processing. Once loaded, the image is then drawn (processing operation 212) to an HTML canvas the application/service (e.g. social networking application). The canvas is then converted (processing operation 214) into a link (e.g. dataUrl), which may be utilized to set the badge application in the main process. The HTML canvas may be returned back (processing operation 214) to the rendering process as a link, which the rendering process can utilize in a command (to the main process) to set the badge icon. The rendering process then transmits (processing operation 216) a command back to the main process to update the user interface and overlay the badge icon over an existing application icon. A non-limiting example of a command used to set the badge icon may be similar to “update-overlay-icon′, dataUrl: ‘ . . . ’}”, where dataUrl is the link obtained from previous processing operations. The main process then creates (processing operation 218) a portable executable (PE) file (e.g. Nativelmage) with the provided link, and calls a function to update an existing application icon with the dynamically generated badge icon.

While examples describes in process flow 200 describe instances where an API architecture separates a main process from a rendering process, it should be understood that processing operations described in process flow 200 can also extend to examples where API architectures do not separate a rendering process from other processes.

FIGS. 3-5 and the associated descriptions provide a discussion of a variety of operating environments in which examples of the invention may be practiced. However, the devices and systems illustrated and discussed with respect to FIGS. 3-5 are for purposes of example and illustration and are not limiting of a vast number of computing device configurations that may be utilized for practicing examples of the invention, described herein.

FIG. 3 is a block diagram illustrating physical components of a computing device 302, for example a mobile processing device, with which examples of the present disclosure may be practiced. Among other examples, computing device 302 may be an exemplary computing device configured for dynamic badge generation and presentation as described herein. In a basic configuration, the computing device 302 may include at least one processing unit 304 and a system memory 306. Depending on the configuration and type of computing device, the system memory 306 may comprise, but is not limited to, volatile storage (e.g., random access memory), non-volatile storage (e.g., read-only memory), flash memory, or any combination of such memories. The system memory 306 may include an operating system 307 and one or more program modules 308 suitable for running software programs/modules 320 such as I0 manager 324, other utility 326 and application 328. As examples, system memory 306 may store instructions for execution. Other examples of system memory 306 may store data associated with applications. The operating system 307, for example, may be suitable for controlling the operation of the computing device 302. Furthermore, examples of the invention may be practiced in conjunction with a graphics library, other operating systems, or any other application program and is not limited to any particular application or system. This basic configuration is illustrated in FIG. 3 by those components within a dashed line 322. The computing device 302 may have additional features or functionality. For example, the computing device 302 may also include additional data storage devices (removable and/or non-removable) such as, for example, magnetic disks, optical disks, or tape. Such additional storage is illustrated in FIG. 3 by a removable storage device 309 and a non-removable storage device 310.

As stated above, a number of program modules and data files may be stored in the system memory 306. While executing on the processing unit 304, program modules 308 (e.g., Input/Output (I/O) manager 324, other utility 326 and application 328) may perform processes including, but not limited to, one or more of the stages of the operations described throughout this disclosure. Other program modules that may be used in accordance with examples of the present invention may include electronic mail and contacts applications, word processing applications, spreadsheet applications, database applications, slide presentation applications, drawing or computer-aided application programs, photo editing applications, authoring applications, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 3 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality described herein may be operated via application-specific logic integrated with other components of the computing device 402 on the single integrated circuit (chip). Examples of the present disclosure may also be practiced using other technologies capable of performing logical operations such as, for example, AND, OR, and NOT, including but not limited to mechanical, optical, fluidic, and quantum technologies. In addition, examples of the invention may be practiced within a general purpose computer or in any other circuits or systems.

The computing device 302 may also have one or more input device(s) 312 such as a keyboard, a mouse, a pen, a sound input device, a device for voice input/recognition, a touch input device, etc. The output device(s) 314 such as a display, speakers, a printer, etc. may also be included. The aforementioned devices are examples and others may be used. The computing device 302 may include one or more communication connections 316 allowing communications with other computing devices 318. Examples of suitable communication connections 316 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 306, the removable storage device 309, and the non-removable storage device 310 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 302. Any such computer storage media may be part of the computing device 302. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

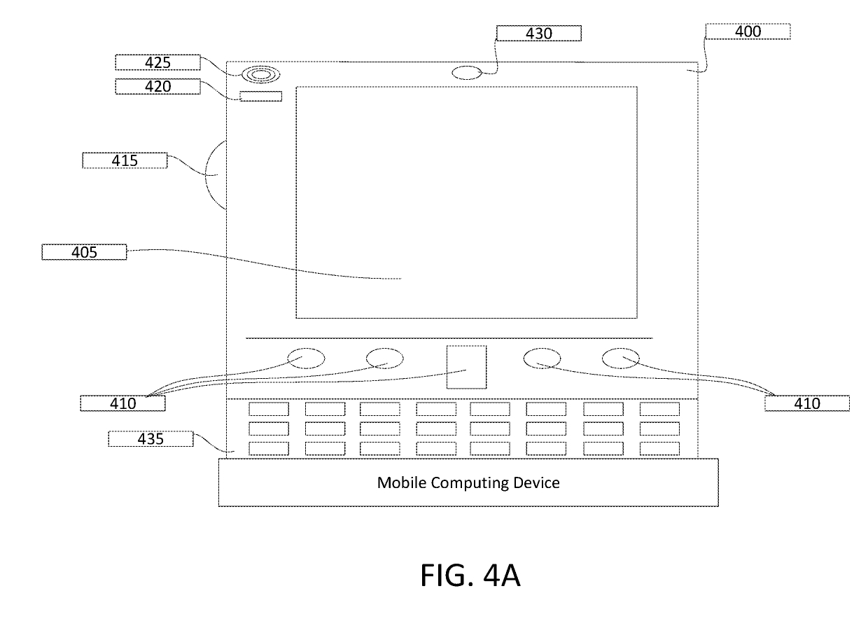

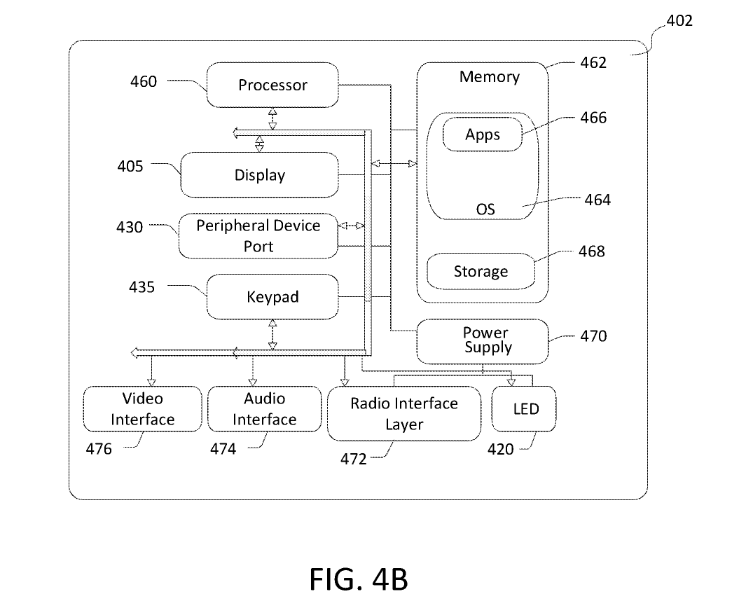

FIGS. 4A and 4B illustrate a mobile computing device 400, for example, a mobile telephone, a smart phone, a personal data assistant, a tablet personal computer, a phablet, a slate, a laptop computer, and the like, with which examples of the invention may be practiced. Mobile computing device 400 may be an exemplary computing device configured for dynamic badge generation and presentation as described herein. Application command control may be provided for applications executing on a computing device such as mobile computing device 400. Application command control relates to presentation and control of commands for use with an application through a user interface (UI) or graphical user interface (GUI). In one example, application command controls may be programmed specifically to work with a single application. In other examples, application command controls may be programmed to work across more than one application. With reference to FIG. 4A, one example of a mobile computing device 400 for implementing the examples is illustrated. In a basic configuration, the mobile computing device 400 is a handheld computer having both input elements and output elements. The mobile computing device 400 typically includes a display 405 and one or more input buttons 410 that allow the user to enter information into the mobile computing device 400. The display 405 of the mobile computing device 400 may also function as an input device (e.g., touch screen display). If included, an optional side input element 415 allows further user input. The side input element 415 may be a rotary switch, a button, or any other type of manual input element. In alternative examples, mobile computing device 400 may incorporate more or less input elements. For example, the display 405 may not be a touch screen in some examples. In yet another alternative example, the mobile computing device 400 is a portable phone system, such as a cellular phone. The mobile computing device 400 may also include an optional keypad 435. Optional keypad 435 may be a physical keypad or a “soft” keypad generated on the touch screen display or any other soft input panel (SIP). In various examples, the output elements include the display 405 for showing a GUI, a visual indicator 420 (e.g., a light emitting diode), and/or an audio transducer 425 (e.g., a speaker). In some examples, the mobile computing device 400 incorporates a vibration transducer for providing the user with tactile feedback. In yet another example, the mobile computing device 400 incorporates input and/or output ports, such as an audio input (e.g., a microphone jack), an audio output (e.g., a headphone jack), and a video output (e.g., a HDMI port) for sending signals to or receiving signals from an external device.

FIG. 4B is a block diagram illustrating the architecture of one example of a mobile computing device. That is, the mobile computing device 400 can incorporate a system (i.e., an architecture) 402 to implement some examples. In one examples, the system 402 is implemented as a “smart phone” capable of running one or more applications (e.g., browser, e-mail, calendaring, contact managers, messaging clients, games, and media clients/players). In some examples, the system 402 is integrated as a computing device, such as an integrated personal digital assistant (PDA), tablet and wireless phone.

One or more application programs 466 may be loaded into the memory 462 and run on or in association with the operating system 464. Examples of the application programs include phone dialer programs, e-mail programs, personal information management (PIM) programs, word processing programs, spreadsheet programs, Internet browser programs, messaging programs, and so forth. The system 402 also includes a non-volatile storage area 468 within the memory 462. The non-volatile storage area 468 may be used to store persistent information that should not be lost if the system 402 is powered down. The application programs 466 may use and store information in the non-volatile storage area 468, such as e-mail or other messages used by an e-mail application, and the like. A synchronization application (not shown) also resides on the system 402 and is programmed to interact with a corresponding synchronization application resident on a host computer to keep the information stored in the non-volatile storage area 468 synchronized with corresponding information stored at the host computer. As should be appreciated, other applications may be loaded into the memory 462 and run on the mobile computing device (e.g. system 402) described herein.

The system 402 has a power supply 470, which may be implemented as one or more batteries. The power supply 470 might further include an external power source, such as an AC adapter or a powered docking cradle that supplements or recharges the batteries.

The system 402 may include peripheral device port 430 that performs the function of facilitating connectivity between system 402 and one or more peripheral devices. Transmissions to and from the peripheral device port 430 are conducted under control of the operating system (OS) 464. In other words, communications received by the peripheral device port 430 may be disseminated to the application programs 466 via the operating system 464, and vice versa.

The system 402 may also include a radio interface layer 472 that performs the function of transmitting and receiving radio frequency communications. The radio interface layer 472 facilitates wireless connectivity between the system 402 and the “outside world,” via a communications carrier or service provider. Transmissions to and from the radio interface layer 472 are conducted under control of the operating system 464. In other words, communications received by the radio interface layer 472 may be disseminated to the application programs 566 via the operating system 464, and vice versa.

The visual indicator 420 may be used to provide visual notifications, and/or an audio interface 474 may be used for producing audible notifications via the audio transducer 425 (as described in the description of mobile computing device 400). In the illustrated example, the visual indicator 420 is a light emitting diode (LED) and the audio transducer 425 is a speaker. These devices may be directly coupled to the power supply 470 so that when activated, they remain on for a duration dictated by the notification mechanism even though the processor 460 and other components might shut down for conserving battery power. The LED may be programmed to remain on indefinitely until the user takes action to indicate the powered-on status of the device. The audio interface 474 is used to provide audible signals to and receive audible signals from the user. For example, in addition to being coupled to the audio transducer 425 (shown in FIG. 4A), the audio interface 474 may also be coupled to a microphone to receive audible input, such as to facilitate a telephone conversation. In accordance with examples of the present invention, the microphone may also serve as an audio sensor to facilitate control of notifications, as will be described below. The system 402 may further include a video interface 476 that enables an operation of an on-board camera 430 to record still images, video stream, and the like.

A mobile computing device 400 implementing the system 402 may have additional features or functionality. For example, the mobile computing device 400 may also include additional data storage devices (removable and/or non-removable) such as, magnetic disks, optical disks, or tape. Such additional storage is illustrated in FIG. 4B by the non-volatile storage area 468.

Data/information generated or captured by the mobile computing device 400 and stored via the system 402 may be stored locally on the mobile computing device 400, as described above, or the data may be stored on any number of storage media that may be accessed by the device via the radio 472 or via a wired connection between the mobile computing device 400 and a separate computing device associated with the mobile computing device 400, for example, a server computer in a distributed computing network, such as the Internet. As should be appreciated such data/information may be accessed via the mobile computing device 400 via the radio 472 or via a distributed computing network. Similarly, such data/information may be readily transferred between computing devices for storage and use according to well-known data/information transfer and storage means, including electronic mail and collaborative data/information sharing systems.

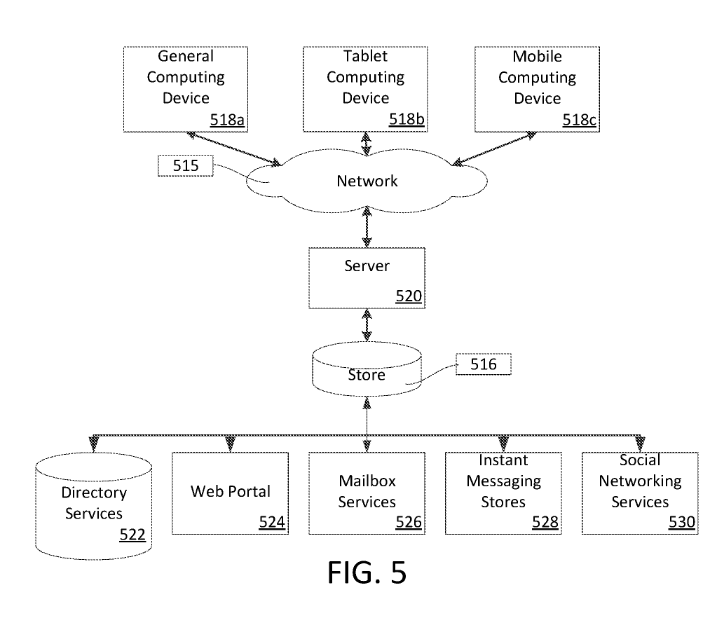

FIG. 5 illustrates one example of the architecture of a system for providing an application that reliably accesses target data on a storage system and handles communication failures to one or more client devices, as described above. The system of FIG. 5 may be an exemplary system configured for dynamic badge generation and presentation as described herein. Target data accessed, interacted with, or edited in association with programming modules 308 and/or applications 320 and storage/memory (described in FIG. 3) may be stored in different communication channels or other storage types. For example, various documents may be stored using a directory service 522, a web portal 524, a mailbox service 526, an instant messaging store 528, or a social networking site 530, I0 manager 324, other utility 326, application 328 and storage systems may use any of these types of systems or the like for enabling data utilization, as described herein. A server 520 may provide storage system for use by a client operating on general computing device 302 and mobile device(s) 400 through network 515. By way of example, network 515 may comprise the Internet or any other type of local or wide area network, and a client node may be implemented for connecting to network 515. Examples of a client node comprise but are not limited to: a computing device 302 embodied in a personal computer, a tablet computing device, and/or by a mobile computing device 400 (e.g., mobile processing device). As an example, a client node may connect to the network 515 using a wireless network connection (e.g. WiFi connection, Bluetooth, etc.). However, examples described herein may also extend to connecting to network 515 via a hardwire connection. Any of these examples of the client computing device 302 or 400 may obtain content from the store 516.

Reference has been made throughout this specification to “one example” or “an example,” meaning that a particular described feature, structure, or characteristic is included in at least one example. Thus, usage of such phrases may refer to more than just one example. Furthermore, the described features, structures, or characteristics may be combined in any suitable manner in one or more examples.

One skilled in the relevant art may recognize, however, that the examples may be practiced without one or more of the specific details, or with other methods, resources, materials, etc. In other instances, well known structures, resources, or operations have not been shown or described in detail merely to observe obscuring aspects of the examples.

While sample examples and applications have been illustrated and described, it is to be understood that the examples are not limited to the precise configuration and resources described above. Various modifications, changes, and variations apparent to those skilled in the art may be made in the arrangement, operation, and details of the methods and systems disclosed herein without departing from the scope of the claimed examples.

What is claimed is:

1. A method comprising:
accessing, by an application executing on a computing device, data associated with a user account of the application;
detecting a status of the user account with respect to satisfaction of a badge count threshold for display of a specific badge within the application;
in response to the detected status, dynamically generating a badge icon for the specific badge, wherein the badge icon comprises image content that is rendered in real-time for the detected status; and
presenting, through a user interface of the application, the badge icon.

2. The method of claim 1, wherein the application is a social networking application configured for team collaboration, and wherein the user account is a member of a team within the social networking application.

3. The method of claim 1, wherein the presenting, updates an existing application icon by overlaying the badge icon over the existing application icon.

4. The method of claim 3, wherein the dynamically generating of the content further comprises: rendering image content in a markup language format, generating a link to the rendered image content and providing the link for presentation of the image content as the badge icon, and wherein the presenting sets the badge icon over the existing application icon using the link to the rendered image content.

5. The method of claim 4, wherein the rendering of the content further comprises creating a scalable vector graphic for the image content, converting the scalable vector graphic to binary data, generating a markup language tag for the image content based on the binary data, drawing the image content to a markup language canvas based on the markup language tag and generating the link based on a result of drawing the image content to the markup language canvas.

6. The method of claim 5, wherein the rendering of the image content is executed by a rendering process of a framework for application generation, and wherein the rendering process is separate from a main process of the framework for application generation, and wherein the main process of the framework for application generation receives the rendered image content from the rendering process and configures the rendered image content for presentation within the user interface of the application.

7. The method of claim 4, wherein the rendering further comprises analyzing user specific user signal data collected from the application and selecting the image content based on an analysis of the specific user signal data.

8. A system comprising:
at least one processor; and
a memory, operatively connected with the at least one processor, storing computer-executable instructions that, when executed by the at least one processor, causes the at least one processor to execute a method that comprises:
accessing, by an application executing on a computing device, data associated with a user account of the application;
detecting a status of the user account with respect to satisfaction of a badge count threshold for display of a specific badge within the application;
in response to the detected status, dynamically generating a badge icon for the specific badge, wherein the badge icon comprises image content that is rendered in real-time for the detected status; and
presenting, through a user interface of the application, the badge icon.

9. The system of claim 8, wherein the application is a social networking application configured for team collaboration, and wherein the user account is a member of a team within the social networking application.

10. The system of claim 8, wherein the presenting, updates an existing application icon by overlaying the badge icon over the existing application icon.

11. The system of claim 10, wherein the dynamically generating of the content further comprises: rendering image content in a markup language format, generating a link to the rendered image content and providing the link for presentation of the image content as the badge icon, and wherein the presenting sets the badge icon over the existing application icon using the link to the rendered image content.

12. The system of claim 11, wherein the rendering of the content further comprises creating a scalable vector graphic for the image content, converting the scalable vector graphic to binary data, generating a markup language tag for the image content based on the binary data, drawing the image content to a markup language canvas based on the markup language tag and generating the link based on a result of drawing the image content to the markup language canvas.

13. The system of claim 12, wherein the rendering of the image content is executed by a rendering process of a framework for application generation, and wherein the rendering process is separate from a main process of the framework for application generation, and wherein the main process of the framework for application generation receives the rendered image content from the rendering process and configures the rendered image content for presentation within the user interface of the application.

14. The system of claim 11, wherein the rendering further comprises analyzing user specific user signal data collected from the application and selecting the image content based on an analysis of the specific user signal data.

15. A computer-readable medium storing computer-executable instructions that, when executed by at least one processor, causes the at least one processor to execute a method comprising:
accessing, by an application executing on a computing device, data associated with a user account of the application;
detecting a status of the user account with respect to satisfaction of a badge count threshold for display of a specific badge within the application;
in response to the detected status, dynamically generating a badge icon for the specific badge, wherein the badge icon comprises image content that is rendered in real-time for the detected status; and
presenting, through a user interface of the application, the badge icon.

16. The computer-readable medium of claim 15, wherein the application is a social networking application configured for team collaboration, and wherein the user account is a member of a team within the social networking application.

17. The computer-readable medium of claim 15, wherein the presenting, updates an existing application icon by overlaying the badge icon over the existing application icon.

18. The computer-readable medium of claim 17, wherein the dynamically generating of the content further comprises: rendering image content in a markup language format, generating a link to the rendered image content and providing the link for presentation of the image content as the badge icon, and wherein the presenting sets the badge icon over the existing application icon using the link to the rendered image content.

19. The computer-readable medium of claim 18, wherein the rendering of the content further comprises creating a scalable vector graphic for the image content, converting the scalable vector graphic to binary data, generating a markup language tag for the image content based on the binary data, drawing the image content to a markup language canvas based on the markup language tag and generating the link based on a result of drawing the image content to the markup language canvas.

20. The computer-readable medium of claim 19, wherein the rendering of the image content is executed by a rendering process of a framework for application generation, and wherein the rendering process is separate from a main process of the framework for application generation, and wherein the main process of the framework for application generation receives the rendered image content from the rendering process and configures the rendered image content for presentation within the user interface of the application.
